(19) United States
(12) Patent Application Publication
(10) Pub. No.: US 2002/0008700 A1
(43) Pub. Date: Jan. 24, 2002

(54) Three-dimensional modeling system

(76) Inventor: Naoki Fuki, Okazaki-city (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 09/858,641

(22) Filed: May 17, 2001

(30) Foreign Application Priority Data
Jun. 7, 2000 (JP) 2000-170866

(51) Int. Cl. G06T 15/40

(52) U.S. Cl. 345/422

(57) ABSTRACT

In a three-dimensional modeling system, a main computer of a CAD apparatus reads out of a memory a three-dimensional model without corner rounding, and extracts all the sequences of corner rounding for edges to be rounded. After that, the size of corner rounding of each individual edge is registered. Furthermore, a number of the sequences is reduced in accordance with an order of priority defined by the designer. After that, in accordance with the respective sequences, each edge of the three-dimensional model is subjected to corner rounding. When all the sequences have been completed and if the results of corner rounding converge, the solid shape of each finished pattern is displayed. This enables the designer to select a shape matching his intention.

### BACKGROUND OF THE INVENTION

1. Field of the Invention

The present invention relates to an improved technique for enabling a computer-supported three-dimensional modeling system, such as a CAD system or a CAE system, and a memory media incorporating a computer program applicable thereto, to subject a three-dimensional model it has designed to edge graphic processing, such as rounding of corners, and thereby design a desired three-dimensional shape.

2. Description of Related Art

In recent years, there has been an ongoing transition from the prior stream of design process based on drawings two-dimensionally prepared by a CAD system to a design flow based on a directly prepared three-dimensional model.

A designer, when designing a three-dimensional model, has to apply to individual edges (sides) edge graphic processing, such as rounding the corners of or chamfering edges, which currently takes an unexpectedly long time. Especially for a shape having positions in each of which a plurality of edges converge on a single point, there can be a number of deferent sequences to round the corners, and following wrong sequences could often result in failure to form the intended shape or to round the corners.

The method may differ with the CAD system (CAD software) that is used, but according to the conventional technology, a method to designate the size of the eventual rounded corners after selecting individual edges and to execute the rounding is adopted in many cases, and in such a case there is no other way than for the designer himself to determine after trial and error which edge in the sequence he should begin with.

### SUMMARY OF THE INVENTION

The present invention is made to solve the above-noted problem. An object of the present invention is to provide a three-dimensional modeling system or a memory media having a computer program applicable thereto, which makes possible a reduction in the number of man-hours spent on designing, i.e. a substantial saving in designing time.

To achieve the above object, a three-dimensional modeling system has an arithmetic unit for automatic designing of a three-dimensional model, wherein the arithmetic unit or the computer program in particular subjects the three-dimensional model to edge graphic processing including the rounding of corners by carrying out the steps of:

(1) extracting a plurality of different sequences for executing edge graphic processing on a plurality of edge parts in the three-dimensional model;

(2) carrying out the edge graphic processing on the edge parts in accordance with the respective sequences,

(3) outputting all finished shapes of the edge parts obtained separately in the sequences as a result of the edge graphic processing to have a designer select, among them, target shapes of the edge parts most matching his intention in one of the sequences; and

(4) registering the target shapes of the edges that are selected and inputted by the designer.

This saves the designer (operator) from the need to think about an adequate sequence of graphic processing and their results in a trial and error process, and enables him to do easily the shaping aspect of designing. Therefore, a reduction in the number of man-hours spent on designing, i.e. a substantial saving in designing time, is made possible.

Incidentally, an “edge part” in this specification is defined to be essentially any “part to which edge graphic processing is to be applied” including a part formed between two faces approaching each other (they need not actually meet each other) in addition to a part (side) formed by two faces actually meeting each other. An edge part having a curvature is expressed as a “rounded corner”, and this is supposed to be synonymous to what is expressed as a “blend or fillet” elsewhere.

On the other hand, the three-dimensional modeling system is provided with a server for storing a three-dimensional model and a plurality of computer terminals communicably connected to the server. And the computer terminals or the computer programs subject the three-dimensional model to edge graphic processing including the rounding of corners by carrying out the steps of:

(1) reading the three-dimensional model stored in the server;

(2) extracting a plurality of different sequences for executing edge graphic processing on a plurality of edge parts in the three-dimensional model so read out;

(3) carrying out the edge graphic processing on the edge parts in accordance with the respective sequences;

(4) outputting all finished shapes of the edge parts obtained separately in the sequences as a result of the edge graphic processing to have a designer select, among them, target shapes of the edge parts most matching his intention in one of the sequences; and

(5) registering the target shapes of the edges that are selected and inputted by the designer.

This saves the designer (operator) from the need to think about the sequences of graphic processing and their results on a trial and error basis, and enables him to do easily the shaping aspect of designing. Therefore, a reduction in the number of man-hours spent on designing, i.e. a substantial saving in designing time, is made possible. Furthermore, the resultant networking of the whole system enables the exchange (transmission and reception) of data between different departments of the same company to be appropriately accomplished. Data can also be appropriately exchanged (transmitted and received) with another company through development of a communication environment between the exchanging parties.

In particular, where there is any edge part consisting of two non-parallel different faces and two or more such edge parts meet one another, the finished three-dimensional shape of the edge parts differ with the sequence in which edge graphic processing, such as corner rounding and chamfering, is carried out on individual edge parts. In such a case, the plurality of sequences for executing the edge graphic processing may be extracted with respect to the mutually meeting individual edge parts. This makes it possible, even if the finished three-dimensional shapes on a corner where the edge parts mutually meet vary with a difference of sequence of edge graphic processing, to readily recognize all the patterns of the finished shapes based on the difference of sequence, and to surely obtain, among them, the shape intended by the designer without entailing troublesome work.

Further, according to an aspect of the invention, after carrying out graphic processing in the sequences of edge graphic processing extracted as described above, it is determined whether or not the results of processing have converged and, if not, that fact is notified. This facilitates correction of any error in the dimensions or the like of rounded corners or chamfered parts specified by the designer, and results in a three-dimensional modeling system excelling in practical usefulness.

Further, according to another aspect of the invention, when extracting the plurality of sequences of edge graphic processing as referred to above, a certain number of sequences may be deleted out of all the extracted sequences of edge graphic processing in accordance with an order of priority based on mutual relationship among individual edge parts, and edge graphic processing is accomplished on the basis of the remaining sequences of processing. For instance, some of the sequences of edge graphic processing may be deleted according to a relative dimensional relationship among individual edge parts. Thus, more specifically, where an edge part having a greater rounded corner (curvature size) is to be given priority, only sequences in each of which graphic processing is performed on edge parts in the descending order of the rounded corner size are selected (others are excluded), and the number of sequences of edge graphic processing can be reduced correspondingly.

According to further aspects of the invention, the procedure of edge graphic processing can be standardized, and such inconveniences as impracticable, wrong graphic processing attempts or differences in the shape of the finished three-dimensional model from one designer (operator) to another can be eliminated. Moreover, since in this case the succeeding steps of graphic processing, displays and the like are outputted with respect to the reduced number of sequences of edge graphic processing, the serial working hours can be reduced.

According to the further aspect of the invention, after carrying out graphic processing in the reduced number of sequences of edge graphic processing as described above, it is determined whether or not the results of processing have converged and, if not, the definition of the order of priority among the individual edge parts is altered. This facilitates correction of any error in the order of priority as defined by the designer to provide a new three-dimensional shape, and results in a three-dimensional modeling system excelling in practical usefulness.

According to the further aspect of the invention, if the results of graphic processing have not converged, error information is outputted and, for instance, indicated on a display. Confirmation of the error information by the designer (operator) facilitates re-designing.

### BRIEF DESCRIPTION OF THE DRAWING

Other features and advantages of the present invention will be appreciated, as well as methods of operation and the function of the related parts, from a study of the following detailed description, the appended claims, and the drawings, all of which form a part of this application. In the drawings:

FIG. 1 is a block diagram illustrating a CAD system in a first embodiment of the present invention;

FIG. 2 is a perspective view illustrating an example of three-dimensional model;

FIG. 3 is a diagram in which edges a, b and c are separately shown in bold lines;

FIG. 4 is a flowchart showing a designing procedure of corner rounding;

FIG. 5 is a perspective view of a three-dimensional model;

FIG. 6 is an enlarged perspective view illustrating edge parts;

FIG. 7 is a schematic block diagram showing a CAD system according to a second embodiment of the present invention; and

FIG. 8 is a flowchart showing a designing procedure of corner rounding in the second embodiment.

### DETAILED DESCRIPTION OF THE PREFERRED EMBODIMENTS

First Embodiment

Modes of implementation embodying the present invention will be described below with reference to drawings.

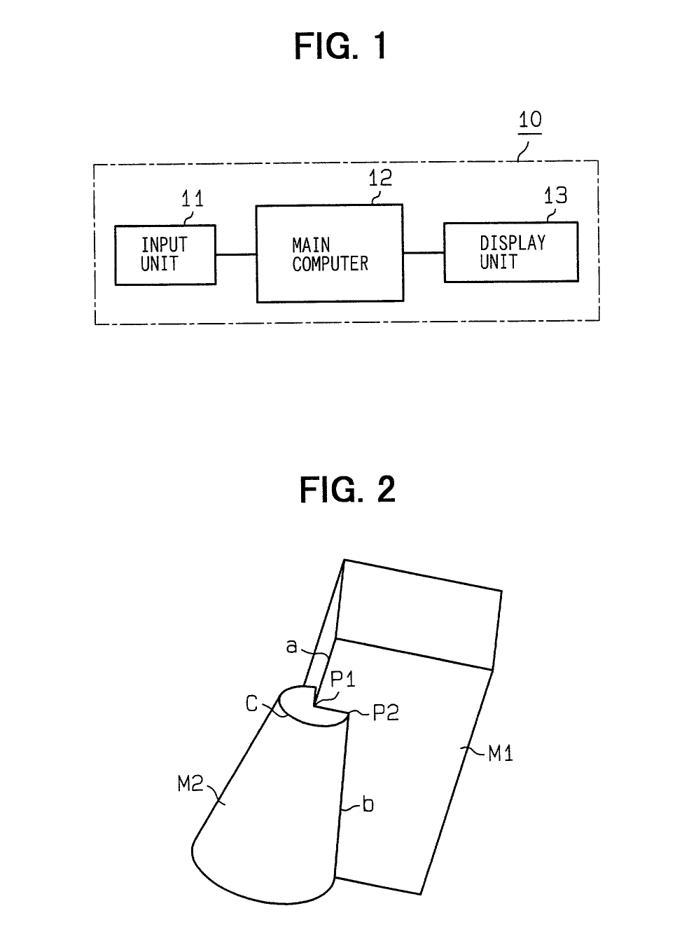

FIG. 1 is a block diagram schematically illustrating the configuration of a three-dimensional CAD system. As shown in FIG. 1, a CAD apparatus 10 consists of an input unit 11 which consists of a keyboard, a mouse or the like, a main computer 12 as an arithmetic unit constituting the core of this system, and a display unit 13. The main computer 12, as is well known, is provided with a CPU, a memory or the like, has various functions for automatic designing of three-dimensional models and executes a computer program incorporated in a memory media (not shown).

Details of the CAD apparatus 10 in this embodiment, which has functions for appropriate application of such aspects of edge graphic processing as corner rounding and chamfering in designing a three-dimensional model to the three-dimensional model will be described below.

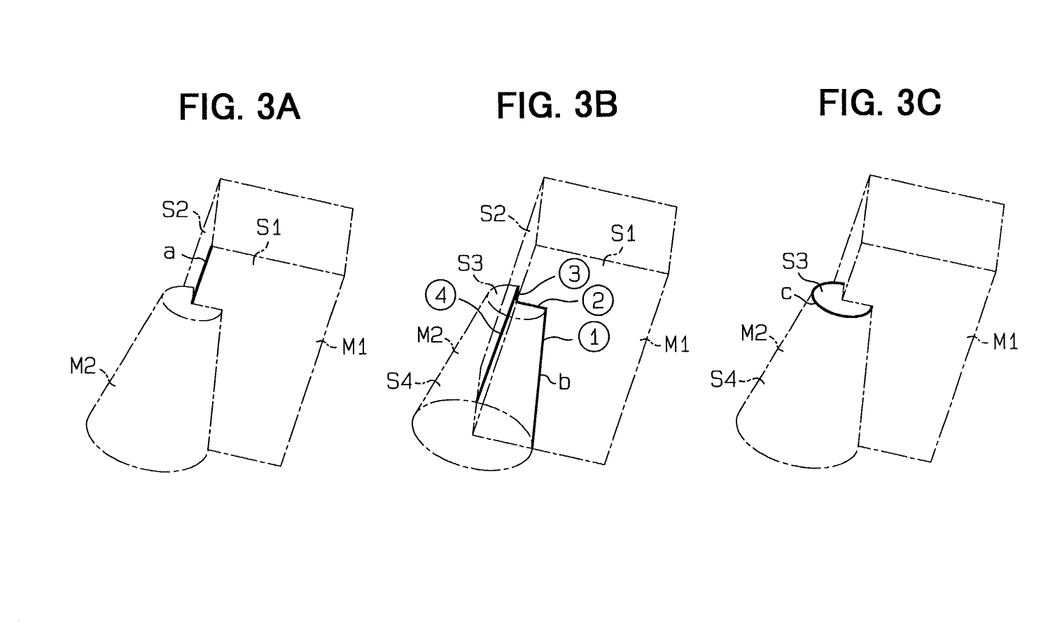

For example, here is considered a three-dimensional model combining a rectangular solid body M1 and a conical solid body M2 as illustrated in FIG. 2. This three-dimensional model has edges a, b and c, and FIG. 3 separately illustrates the edges a, b and c, represented in bold lines to clearly show their respective positions. In this case, as shown in FIG. 3A, the edge a is provided in the position where faces S1 and S2 of the solid body M1 meet; as shown in FIG. 3B, the edge b is provided in the position where faces (S1 and S2) of the solid body M1 and faces (S3 and S4) of the solid body M2 meet; and as shown in FIG. 3C, the edge c is provided in the position where faces S3 and S4 of the solid body M2 meet. Incidentally, if each edge is to be formed by two mutually meeting faces, the edge b shown in FIG. 3C should actually consists of four edges (encircled numerals 1, 2, 3 and 4 in the figure), but they are collectively deemed to be a single edge for the sake of convenience. Further, as shown in FIG. 2, the edges a and b meet each other at a point P1, and the edges b and c meet each other at a point P2.

In the three-dimensional model referred to above, to extract all the sequences each having different pattern for carrying out corner rounding on the edges a, b and c:

(1) a→b→c

(2) a→c→b

(3) b→a→c

(4) b→c→a

(5) c→a→b

(6) c→b→a

there are these six alternatives. In this case, the finished solid shape of corner rounding on the individual edges a, b and c will differ, depending on which sequence pattern is chosen. However, since the edges a and c do not directly meet each other, “a→c→b” and “c→a→b” result in the same shape of corner rounding, and so do “b→a→c” and “b→c→a”. Therefore, for producing different corner rounding shape, out of the above-listed sequences (1) through (6), (2) and (4) are excluded and the remaining four are available (of course, it mean the same to regard as available the four sequences excluding (3) and (5)).

Conventionally, the designer has designed the three-dimensional model in such a manner that the intended shape is determined by considering these sequences in his brain and executing all the sequences. By contrast, in this embodiment, the CAD apparatus 10 simplifies the designer's work, which has been troublesome, by extracting the above-listed sequences through arithmetic processing and appropriately executing edge graphic processing according to the respective sequences.

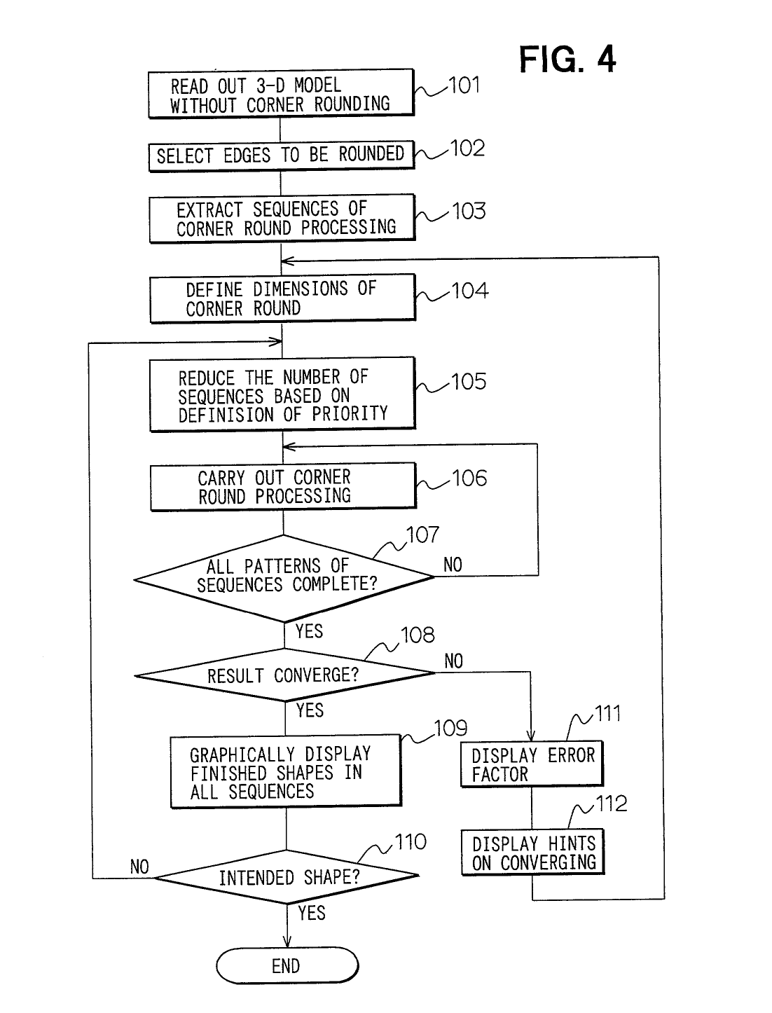

FIG. 4 is a flowchart showing the designing procedure of corner rounding implemented by the main computer 12. Incidentally, it is supposed that a three-dimensional model without corner rounding is already prepared and stored in a memory in the CAD apparatus 10.

First at step 101, the three-dimensional model without corner rounding is read out of the memory, and at the next step 102, edges whose corners should be rounded out of all the edges of the model that has been read out are selected.

Then at step 103, all the sequences available for executing corner rounding on the selected edges are extracted. For instance, if the edges a, b and c in the three-dimensional model shown above in FIG. 2 are to be founded, the aforementioned six sequences will be extracted. Further at step 104, the size (dimensions) of corner rounding indicated by the designer will be associated with each individual edge.

After that, at step 105, the total number of corner rounding sequences is reduced in accordance with the order of priority defined in advance by the designer. This order of priority is defined on the basis of the mutual relationship among individual edges, and can be, for instance:

a descending (or ascending) order of the corner rounding size.

an order based on the finished solid shape (same shape); or

an order based on edge numbers assigned in advance.

In accordance with one of these or other definitions, the available number of corner rounding sequences is reduced. Where the number of corner rounding sequences is reduced for the three-dimensional model shown above in FIG. 2 according to the priority order based on the finished solid shape, at least two sequences (e.g. (2) and (4) cited above) are excluded as being unnecessary. Thus in the case of FIG. 2 above, at this step 105, the number of corner rounding sequences is reduced from six to four. However, if the order of priority is not defined by the designer, the number is not reduced.

Then at step 106, in accordance with the corner rounding sequences determined as described above, each edge of the three-dimensional model is rounded. The processing of this corner rounding is repeated until the whole sequences are completed (until the response to step 107 becomes YES), and upon completion of processing based on the whole sequences, the process goes ahead to step 108.

At step 108, it is determined whether or not the results of corner rounding have converged. If, for instance, there are such problems that it is physically impossible to implement any solid shape in the corner rounding dimensions indicated by the designer or appropriate edge graphic processing is impossible in any of the corner rounding sequences stated above, the results are judged not to have converged.

If the results have converted, the process goes ahead to step 109, where the finished solid shapes of different patterns according to the respective sequences are graphically displayed on the display unit 13. Then the designer, looking at the display unit 13, judges whether or not the solid shapes of the different patterns include what matches his intention. To add, instead of showing the solid shapes on the display unit 13, the different patterns may be printed with a printing device, such as a color printer. Then, the designer, if he finds a shape matching his intention, selects by manipulating the input unit 11. This results in a YES response at step 110, and the designing procedure for corner rounding is completed.

Or if there is nothing matching the designer's intention in the solid shapes of different patterns, the process returns to step 105, where the designer gives a priority definition anew, and again executes the processing of corner founding.

On the other hand, if the corner rounding according to all the sequences is completed and the results have not converted and the response to step 108 is NO, an error is assumed to have arisen and the process goes ahead to step 111. Then at step 111, the likely factor(s) inviting the error is analyzed and the result is shown on the display unit 13 and at the next step 112, a hint(s) on causing the results to converge is searched for and shown on the display unit 13. Instead of being shown on the display, they may be printed out. After that, process returns to step 104, and the processing steps of associating (altering) the rounding dimensions, reducing the total number of sequences and carrying out corner rounding are executed again (steps 104 through 107).

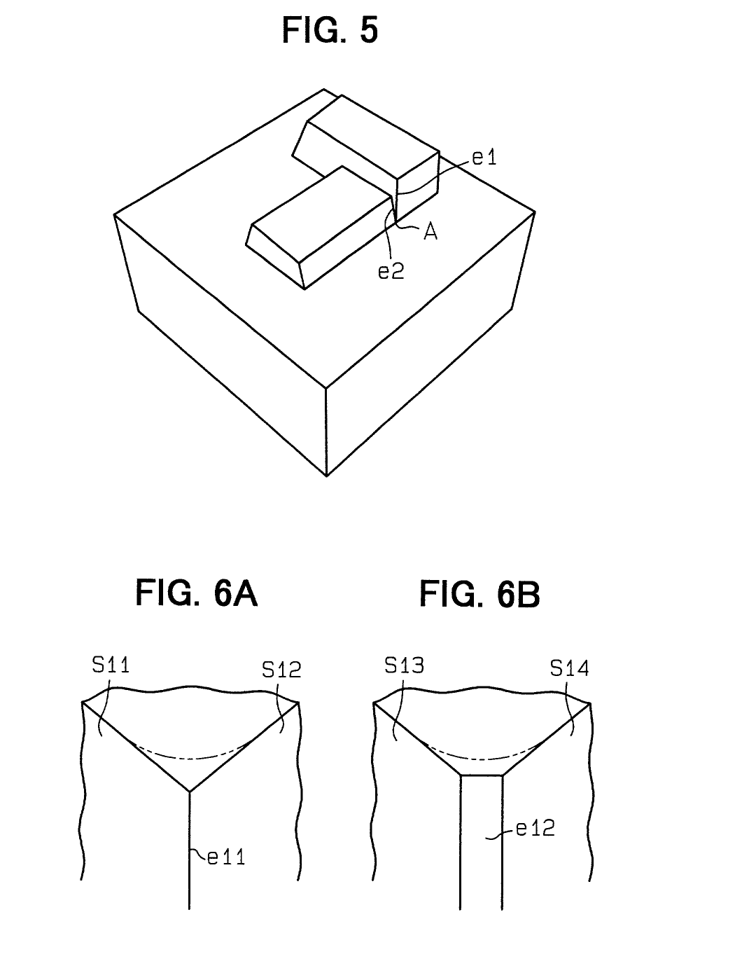

For instance, a case of rounding the corners of edges e1 and e2 in a three-dimensional model like the one shown in FIG. 5 is considered. In this case, the edges e1 and e2 are concentrated on a point A, and unless the sequence of processing these edges e1 and e2 or the rounding dimensions of their corners are properly set, the results of edge graphic processing may fail to have converged. If corners on the edges e1 and e2 are to be rounded in different dimensions and the corner of the edge e2 is too large to round, the cause of the error as error information and a hint(s) on redoing are shown on the display unit 13. The designer may be urged to make a change by displaying a message such as “the corner rounding of the edge e2 is too large. Change the corner rounding to XX.”

Edge graphic processing may be chamfering, instead of corner rounding, and automatic designing according to a menu of the processing sequences can be implemented also for edge parts to be chamfered. In this case, corner rounding and chamfering may as well be mixed in implementation.

When performing edge graphic processing, instead of directly designating the pertinent edge part and subjecting it to that graphic processing, it is also possible to designated two faces and subject the edge part between them to edge graphic processing. For instance when an edge part e11 formed where faces S11 and S12 in the shape illustrated in FIG. 6A is to be subjected to corner rounding, either the edge part e11 can be designated directly or the faces S11 and S12 can be designated. On the other hand, in the shape shown in FIG. 6B, though faces S13 and S14 do not meet each other directly, a hypothetical position in which they will meet each other, if extend, can be deemed to be an edge part e12 to be subjected to corner rounding. In this case, the faces S11 and S12 are designated and corner rounding is processed between them.

It can be made selectable on each occasion whether to directly designate the edge part for edge graphic processing or to designate one face and another between which the edge part is to be subjected to edge graphic processing. Or else, it may be left to automatic determination by the main computer 12 of the CAD apparatus 10 to have the edge part directly designated in the case of the shape shown in FIG. 6A or two faces designated in the case of the shape shown in FIG. 6B.

In the embodiment so far described in detail, the following effects can be obtained.

As the CAD apparatus 10 (main computer 12) extracts sequences of edge graphic processing (corner rounding, chamfering and the like) on many edge parts of a three-dimensional model and automatically prepare three-dimensional drawings according to individual sequences, the designer (CAD operator) need not think about the sequences of graphic processing and their results on a trial and error basis, and is enabled to do easily the shaping aspect of designing. Thus the designer has only to input necessary items in an interactive manner in accordance with a menu indicated by the CAD apparatus 10. Therefore, a reduction in the number of man-hours spent on designing, i.e. a substantial saving in designing time, is made possible.

Although a case in which three edges a, b and c concentrate is described with respect to the above-cited three-dimensional model of FIG. 2, in actual designs a large number of edges often concentrate in a more complex way to further complicate edge graphic processing on individual edges. In such a case, the technique in this embodiment is expected to prove even more effective.

Furthermore, in extracting sequences of edge graphic processing, as the certain number of the sequences are deleted in accordance with a prescribed order of priority and edge graphic processing is performed in accordance with the reduced sequences, the procedure of edge graphic processing can be standardized, and such inconveniences as impracticable, wrong graphic processing attempts or differences in the shape of the finished three-dimensional model from one designer (CAD operator) to another can be eliminated. Moreover, since in this case the succeeding steps of graphic processing, displays and the like are executed according to the edge graphic processing sequences narrowed out of theoretically available sequences, the serial working hours can be reduced.

If the results of edge graphic processing do not converge, the definition of the priority of each edge part is altered, so that any error in the order of priority as defined by the designer can be easily corrected to provide a new three-dimensional shape, and a three-dimensional modeling system excelling in practical usefulness can be implemented. Furthermore, as error information is indicated on the display unit 13, re-designing can be easily accomplished.

Second Embodiment

Next will be described a second embodiment. In this embodiment, a server and a plurality of CAD apparatuses (computer terminals) are connected to each other by a network, and the procedure of designing a three-dimensional model in that environment will be described below.

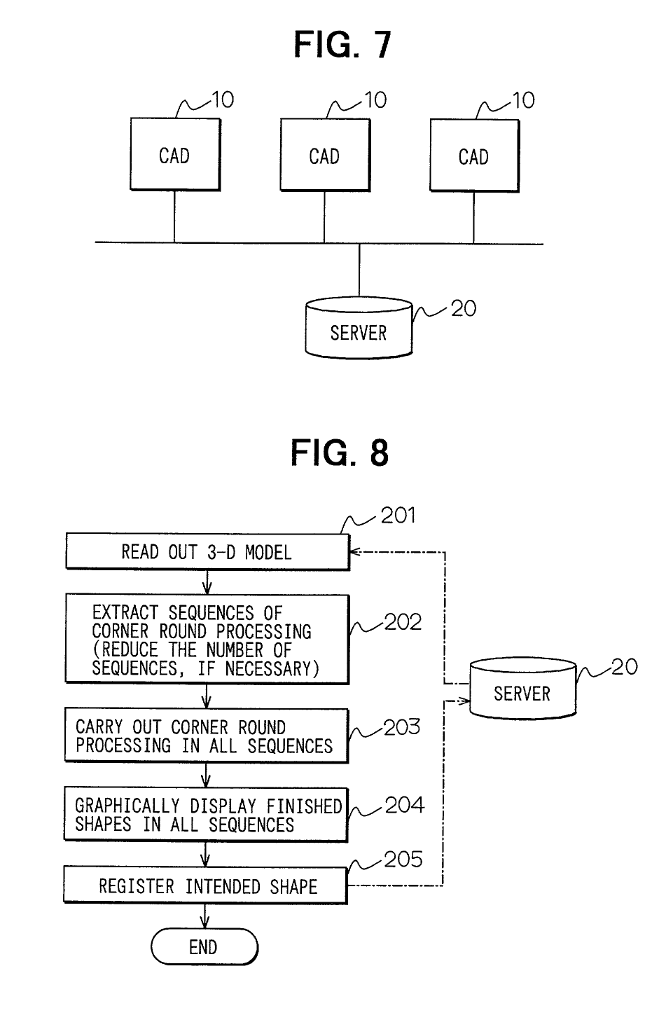

FIG. 7 is a schematic configurational diagram showing the system as a whole. Referring to FIG. 7, a plurality of CAD apparatuses 10 and a server 20 are communicably connected to each other by a LAN. Each of the CAD apparatuses 10, as described with reference to the first embodiment, automatically performs a serial designing procedures, including edge graphic processing, on a three-dimensional model.

FIG. 8 is a flowchart showing the designing procedure with respect to edge graphic processing in this CAD system. However, with reference to FIG. 8, only a general flow will be described while dispensing with illustration and description of what would duplicate the description of the first embodiment.

First at step 201, the three-dimensional model without corner rounding is read out of the server 20, and at the next step 202, a menu showing all sequences having different patterns for executing corner rounding on the edges to be rounded are extracted. At this time, as required, the number of corner rounding sequences is reduced in accordance with the order of priority defined by the designer. After that, at step 203, each edge of the three-dimensional model is rounded in accordance with the reduced corner rounding sequences. At step 204, the finished solid shapes of the edges according to individual sequences are graphically displayed on the display unit 13. Then, as the designer confirms on the display unit 13 finished solid shapes matching his intention, those solid shapes are registered into the server 20 (step 205).

Thus in the second embodiment, as in the first embodiment, the designer (CAD operator) need not think about the sequences of graphic processing and their results on a trial and error basis, and is enabled to do easily the shaping aspect of designing. Therefore, a reduction in the number of man-hours spent on designing, i.e. a substantial saving in designing time, is made possible. Furthermore, the resultant networking of the whole system enables the exchange (transmission and reception) of data between different departments of the same company to be appropriately accomplished. Data can also be appropriately exchanged (transmitted and received) with another company through development of a communication environment between the exchanging parties.

To add, the present invention can be embodied in the following modes besides the above-described.

In the designing procedure described above with reference to FIG. 4, the reduction of the number of patterns for the corner rounding sequence (processing at step 105) may be dispensed with, and instead corner rounding may be implemented according to all the patterns for the sequence of corner rounding (result of extraction at step 103). Even in this case, however, if the results of edge graphic processing do not converge, error information indicating that fact may advisably be displayed, and this would facilitate correction of corner rounding dimensions and the like, resulting in the implementation of a three-dimensional CAD system excelling in practical usefulness.

In extracting the sequences of edge graphic processing (corner rounding and the like) with the CAD apparatuses 10, the edge parts to be covered need not be limited to those directly meeting each other, but may also include sequences of edge graphic processing for edge parts which do not directly meet each other. For instance, it can be determined with respect to two edge parts apart from each other which should be subject to corner rounding first, and corners can be automatically rounded in the order so determined.

Although in the above-described embodiment a three-dimensional modeling system is architected using an apparatus or software commonly known as “CAD”, a three-dimensional modeling system may as well be architected using an apparatus or software commonly known as “CAE” or “CAM”.

What is claimed is:

1. A memory media applicable to an arithmetic unit of a three-dimensional modeling system for executing edge graphic processing on three-dimensional model stored therein, the memory media storing a computer program comprising steps of:
extracting a plurality of different sequences for executing edge graphic processing on a plurality of edge parts in the three-dimensional model;
carrying out the edge graphic processing on the edge parts in accordance with the respective sequences;
outputting all finished shapes of the edge parts obtained separately in the sequences as a result of the edge graphic processing to have a designer select target finished shapes of the edge parts most matching his intention in one of the sequences; and
registering the target finished shapes of the edge parts that are selected and inputted by the designer.

2. A memory media according to claim 1, wherein, the computer program makes it possible that, where there are a plurality of the edge parts each consisting of two non-parallel different faces and at least two of the edge parts meet one another, the plurality of sequences of edge graphic processing are extracted with respect to the mutually meeting individual edge parts.

3. A memory media according to claim 1, the computer program further comprising steps of;
determining, after carrying out the edge graphic processing in accordance with the sequences for executing edge graphic processing, whether or not results of the edge graphic processing have converged and, if not, outputting an error information to notify the designer of no convergence.

4. A memory media according to claim 1, the computer program further comprising steps of:
registering dimensions of the respective edge parts that are input by the designer, after the plurality of sequences for executing edge graphic processing are extracted.

5. A memory media according to claim 1, the computer program further comprising steps of:
Reducing, after extracting the sequences for executing edge graphic processing, the number of the sequences for executing edge graphic processing in accordance with a definition of order of priority decided and inputted by the designer based on mutual relationship among the individual edge parts so that the edge graphic processing is accomplished on the basis of the reduced number of sequences for executing edge graphic processing.

6. A memory media according to claim 3, wherein the definition of order of priority is decided by the designer according to a relative dimensional relationship among the individual edge parts.

7. A memory media according to claim 3, the computer program further comprising steps of:
carrying out again, after the designer inputs to modify the definition of order of priority among the individual edge parts upon receipt of the error information, edge graphic processing on a basis of the sequences whose number is reduced according to the modified definition of order of priority.

8. A memory media according to claim 4, the computer program further comprising steps of:
carrying out again, after the designer inputs to modify the registered dimension of any of the edge parts upon receipt of the error information, edge graphic processing on the basis of the modified dimension.

9. A three-dimensional modeling system having an arithmetic unit for automatically designing a solid shape, the arithmetic unit sequentially executing the computer program of the memory media recited in any one of claims 1 to 8.

10. A three-dimensional modeling system provided with a server for storing three-dimensional models and with a plurality of computer terminals communicably connected to the server, the three-dimensional modeling system sequentially executing the computer program of the memory media recited in any one of claims 1 to 9, wherein the computer terminal reads the three-dimensional model stored in the server and, after completing the edge graphic processing, makes the target shapes of the edge parts that are selected and inputted by the designer register to the server.
